(19) United States
(12) Patent Application Publication
(10) Pub. No.: US 2009/0032627 A1
(43) Pub. Date: Feb. 5, 2009

(54) Spice Grinder

(76) Inventor: Charles Z. Krasznai, Bridgeport, CT (US)

Correspondence Address: Lawrence Cruz;Conair Corporation, One Cummings Point Road, STAMFORD, CT, 06902, US

(21) Appl. No.: 12/183,752

(22) Filed: Jul. 31, 2008

Related U.S. Application Data
(60) Provisional application No. 60/962,883, filed on Aug. 1, 2007.

(51) Int. Cl. A47J 42/36

(52) U.S. Cl. 241/36; 241/100; 241/169.1; 241/282.1

(57) ABSTRACT

A spice grinder appliance 1 comprises a base 2 containing an electric motor 8 and associated drive system, an output shaft with a blade 25 attached thereto, and a removable cover 4 surrounding the blade and creating a chamber for spices or food product to be ground or chopped. The removable bowl and rotatable blade quickly and conveniently couple and de-couple from the drive shaft so that the bowl can be removed from the appliance while the blade remains therein in order to prevent contents from spilling out of the bowl.

### CROSS-REFERENCE TO RELATED APPLICATIONS

This patent application relates to and claims priority from previously filed U.S. Provisional No. 60/962,883, filed on 1 Aug. 2007, titled “SPICE GRINDER”.

### BACKGROUND OF THE INVENTION

1. Field of the Invention

The present invention relates to food processing and cooking appliances and, more particularly, to grinding appliances for grinding spices and other food products.

2. Description of Related Art

Various electric grinding appliances exist for grinding spices and similar food products. Such appliances comprise an electric motor, an output spindle, and at least one rotatably mounted blade for chopping and grinding. The blade is positioned within an enclosed chamber that catches ground spices or food product, wherein the chamber can be selectively opened or closed to add, remove or contain spices of food product before, during or after grinding or chopping.

### OBJECT OF THE PRESENT INVENTION

It is an object of the present invention to provide an improved spice grinder appliance. It is a further object of the present invention to provide a spice grinder having a removable bowl and a rotatable blade that quickly and conveniently couples and de-couples from the drive shaft so that the bowl can be removed from the appliance while the blade remains therein in order to prevent contents from spilling out of the bowl.

These an other objects are achieved by the present invention disclosed herein.

### SUMMARY OF THE INVENTION

According to the present invention, a spice grinder appliance comprises a base containing an electric motor and associated drive system, an output shaft with a blade attached thereto, and a removable cover surrounding the blade and creating a chamber for spices or food product to be ground or chopped. The present invention is directed to a spice grinder having a removable bowl and a rotatable blade that quickly and conveniently couples and de-couples from the drive shaft so that the bowl can be removed from the appliance while the blade remains therein in order to prevent contents from spilling out of the bowl.

### BRIEF DESCRIPTION OF THE DRAWINGS

FIG. 1 is a front, perspective view of an appliance according to a preferred embodiment of the present invention.

FIG. 2 is an exploded view of an appliance according to a preferred embodiment of the present invention.

FIG. 3 is a top view of a bowl including a blade assembled therein according to a preferred embodiment of the present invention.

### DESCRIPTION OF THE PREFERRED EMBODIMENT OF THE PRESENT INVENTION

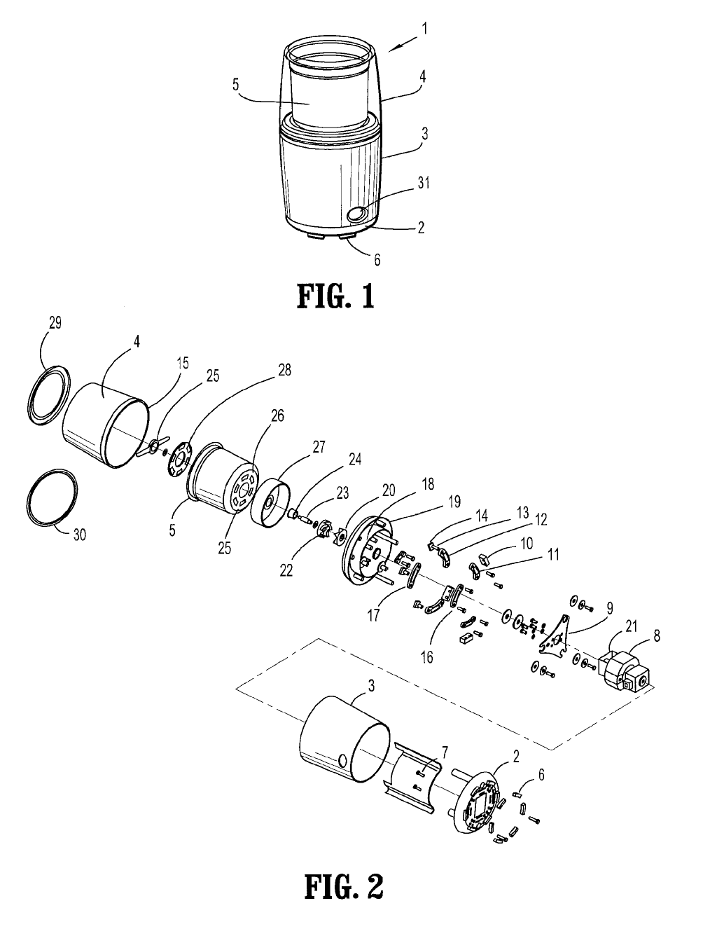

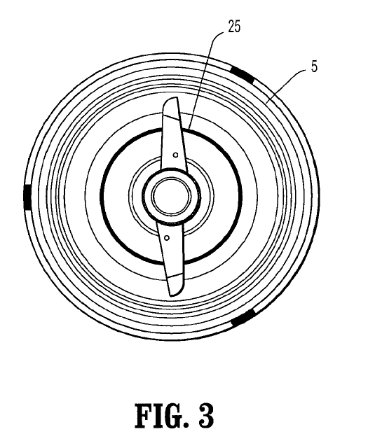

Referring to FIG. 1, a spice grinder appliance 1 comprises a base 2, a lower housing 3, a transparent, removable cover 4, and a bowl 5 mounted to the lower housing 3 and contained within the transparent, removable cover 4. The base includes a set of soft footing pads 6. A separator insert 7 is located internally within the lower housing 3 to support additional components. An electric motor 8 is mounted within the lower housing 3 with a motor mounting plate 9. A first microswitch assembly located at and partially above a rim of the lower housing 3 comprises a microswitch 10, a switch plate 11 for mounting the microswitch 10, a switch shelf 12, a switch spring 13, and switch board 14, which together enable a safety feature in which the motor 8 is not operational unless the microswitch 10 is activated by physical contact with the rim 15 of the cover 4 when the cover 4 is located on the lower housing 3 in an operating position. Second and third microswitch assemblies 16, 17, physically and operationally the same as the first microswitch assembly, are located at equally-spaced locations at and partially above the upper rim 18 of the lower housing 3 formed on the top cover 19 of the lower housing 3.

A motor output coupling 20 is fixed to a driven shaft 21 extending from the motor 8 to rotate therewith. Rotational motion from the motor 8 is then transmitted from the motor output coupling 20 to the blade coupling 22. A blade shaft 23 is attached to the blade coupling 22 and a bearing 24 supports a blade 25 for rotational motion driven by the motor 8. The bowl 5 has an opening 25 in its bottom floor 26 to receive the bearing 24 and shaft 23 so that the blade 25 can be rotationally mounted within the bowl 5 and the blade coupling 22, shaft 23, bearing 24 and blade 25 can be removed with the bowl 5 and stay attached to the bowl 5 when the bowl 5 is decoupled from the output coupling 20 and removed from the appliance 1. The prevents ground spices and food product that are stored in the bowl 5 from leaking out of the bowl 5. A bowl base 27 is attached to the bottom of the bowl 5 and extends downwardly to support the bowl 5 when it is positioned on the top cover 19 of the lower housing 3. A bowl bottom cover 28 is located in the bottom of the bowl 5 to support the blade 25 and its bearing and drive shaft. A blow lid 29 may be provided to cover the contents of the bowl 5. One or more seal rings 30 may be provided to seal between the cover 4 and top cover 19. A control button 31 or a plurality of buttons, or a touch pad, or the like, may be provided to control various functions such as ON/OFF, speed, timer, automatic shut-off, and other functions. The appliance 1 may include a conventional electrical cord (not shown) adapted to plug into an external electrical source such as a wall outlet, or it may include a battery pack (not shown), or both, in order to provide electrical energy to the motor 8.

In operation, a food product such as but not limited to spice plants or food product may be loaded into the bowl 5. The bowl 5 is either already located on the lower housing 3 with the couplings 20, 22 engaged, or the bowl 5 may be so positioned after the spice plants or food product are loaded into the bowl 5. The cover 4 is positioned on the top cover 19 of the lower housing 3 in a manner that safely contains the bowl 5 and that activates the motor 8 by depressing the microswitch assemblies 10, 16, 17. The control button 31 or buttons are manipulated and the blade 25 rotates within the bowl 5 causing the spice plants or food product to be ground. A user can select the time of grinding to achieve a desired size of ground. The rotational speed, dimensions, angles and spacing of the blade 25 and interior of the bowl 5 may be selected during product design to have optimal parameters for desired performance.

While the preferred embodiment of the present invention has been disclosed herein, it is understood that various modification can be made without departing from the scope of the presently claimed invention.

What is claimed is:

1. An appliance for grinding food product, said appliance comprising
a base;
a housing attached to said base;
an electric motor positioned in said housing;
a motor coupling attached to said electric motor to transmit rotational force provided by said electric motor;
a bowl adapted to be removably positioned on said housing and to hold food product therein;
a bottom opening in the bottom of said bowl;
a blade assembly mounted in said bottom opening, said assembly comprising a bearing, a shaft, and a blade, said blade being rotationally mounted relative to said bowl;
a blade coupling attached to said shaft and adapted to engage or disengage said motor coupling when, respectively, said bowl is positioned on or removed from said housing so that during engagement of said blade coupling to said motor coupling, rotational force generated by said electric motor is transmitted to said blade coupling, shaft and blade;
a cover adapted to be positioned on said housing and over said bowl, and to be removed from said housing; and
at least one switch adapted to operationally enable said electric motor when said cover is positioned on said housing, and to operationally disable said electric motor when said cover is removed from said housing.

2. An appliance according to claim 1, further comprising
at least one control button on said housing adapted to be manipulated by a user to operate said appliance.

3. An appliance according to claim 1, further comprising
a lid adapted to be positioned on or removed from said bowl.

4. An appliance according to claim 1, wherein
said cover is transparent.
